(19) United States
(12) Patent Application Publication
(10) Pub. No.: US 2012/0210257 A1
(43) Pub. Date: Aug. 16, 2012

(54) AUTOMATED SYSTEM FOR ANALYZING POWER PLANT OPERATIONS

(75) Inventors: Matthew John Mosley, Simpsonville, SC (US); Christopher Eugene Long, Greer, SC (US); Rohan Saraswat, Hyderabad (IN); Ratna Manedhar Punjala, Hyderabad (IN); Venkatesh Mani Selvaraj, Hyderabad (IN)

(73) Assignee: GENERAL ELECTRIC COMPANY, Schenectady, NY (US)

(21) Appl. No.: 13/025,335

(22) Filed: Feb. 11, 2011

(51) Int. Cl. G06F 3/048; G06F 15/00

(52) U.S. Cl. 715/764; 702/182

(57) ABSTRACT

Systems and methods for analyzing and displaying power plant data are able to access continuous live and/or historical operational data and identify within the data: (a) instances of at least one given type of power plant operation, (b) key events that may occur during an instance of the at least one given type of power plant operation, and (c) one or more time-based segments based on the key events and a physical segmentation of the power plant. Performance aspects for selected identified power plant operation instances can be quantified by comparing the identified instances with metrics that are predefined relative to the key events and segmentation within each type of power plant operation. Selected data associated with the identified instances are provided as electronic output to a user.

### FIELD OF THE INVENTION

The subject matter disclosed herein relates to systems and methods for implementing automated electronic analysis of power plant operations, and more particularly, to systems and methods of identifying, characterizing and visualizing selected data associated with different types of power plant operations.

### BACKGROUND OF THE INVENTION

Highly complex industrial operations such as implemented within a power plant environment often involve the sophisticated coordination of multiple machines and associated processes. Many of the industrial components within such a power plant environment may include sensors or other monitoring equipment in conjunction with a computing device so that the real-time conditions of such components can be electronically tracked. For example, some display panels within a power plant environment are capable of displaying various present plant operating conditions associated with the monitored respective components or processes within the plant.

The operational data for power plants described above is often available only in the form of a continuous time series. In other words, sensors constantly monitor a component and provide a non-stop flow of data such that an operator can observe real-time statistics of the present operational state of various plant components. To pick out specific plant operations from that data is a non-trivial matter.

Some known techniques are able to analyze specific plant operations only by undergoing a manual process of sorting and reviewing information on an ad hoc basis as necessary in response to a particular issue or concern. Such techniques typically involve manually mining reams of data to find particular plant operations and/or events, filtering through those operations/events to find ones that are relevant, extracting a few signals from the data, and then plotting them against one another. All of these lengthy and complex steps are normally done on an ad hoc basis, and typically have to be repeated for each issue as it arises. As such, a need remains to automate and streamline data analysis associated with the events occurring within a plant environment.

The ability to analyze historical data can also be difficult because of the sheer volume of information captured in conventional monitoring systems and limited ways to sort and access such data. Without ways to identify and store data associated with past operational events, an analyst may be forced to manually sort through extensive amounts of prior data to identify desired information. A need thus also remains for providing an ability to sort through and analyze historical power plant data and/or to provide meaningful comparisons of current data to historical data.

Still further, specific plant operations can be quite complex and variable, such that it is difficult to make useful comparisons among different instances of an operation. Analysis of plant operations by a human operator interacting with a data monitoring system can become increasingly difficult as the operator is required to mentally conceptualize and compare numerous abstract parameters associated with the plant environment. Also, visualizing plant operations, particularly visualizing more than one at a time, requires significant levels of arduous data manipulation. All of these realities are significant obstacles to characterizing and visualizing plant operations as part of any monitoring or improvement program. As such, a need also remains for electronic features designed to characterize and visualize data comparisons among power plants and operations thereof.

The art is continuously seeking improved systems and methods for electronically analyzing the conditions and parameters associated with the various components and operations within power plants.

### BRIEF DESCRIPTION OF THE INVENTION

In one exemplary embodiment of the present invention, a method of electronically analyzing power plant data includes establishing a plurality of electronic definitions about a power plant, including: (a) power plant conditions that indicate the beginning and end of at least one given type of power plant operation, (b) key events that may occur during an instance of the at least one given type of power plant operation, and (c) a segmentation of the at least one given type of power plant operation into one or more time-based segments based on the key events and physical segmentation features of the plant. Continuous power plant operational data may then be electronically accessed. Portions of the power plant operational data that show instances of the at least one given type of power plant operation are then identified. Key events and segments within each instance of the at least one given type of power plant operation are also identified. Finally, the identified instances along with the key events and segments identified within each instance are provided as electronic output.

Another exemplary embodiment of the present invention concerns a power plant analysis and display system, comprising at least one processing device, at least one memory and at least one output device. The at least one memory comprises computer-readable instructions for execution by the at least one processing device, wherein the at least one processing device is configured to electronically access continuous power plant operational data, electronically identify portions of the power plant operational data that show instances of at least one given type of predefined plant operation, and also predefined key events and segments within each instance of the at least one given type of plant operation. The at least one output device displays data associated with selected identified instances and characteristics, key events or segments thereof.

### BRIEF DESCRIPTION OF THE DRAWINGS

The invention, in accordance with preferred and exemplary embodiments, together with further advantages thereof, is more particularly described in the following detailed description taken in conjunction with the accompanying drawings in which:

FIG. 1 is block diagram of exemplary hardware and software components within a power plant analysis system of the presently disclosed technology, including such components as the monitored hardware elements within a combined cycle (CC) power plant as well as the server and computer components that access the operational power plant data and characterize and display information in accordance with the disclosed techniques;

FIG. 2 is a flow chart of exemplary steps in a method of analyzing power plant operational data in accordance with aspects of the disclosed technology;

FIG. 3 is a graphical illustration of instance identification in which continuous power plant operational data is analyzed to determine instances of one or more given types of operations;

FIG. 4 is a graphical illustration of the identification within a power plant operational instance of various key events and segmentation based on preconfigured definitions for such aspects in accordance with the disclosed technology;

FIG. 5 is a first exemplary visualization of power plant data analyzed in accordance with the disclosed technology, more particularly illustrating a trend chart showing data associated with one instance, including selected parameters, key events and segments associated therewith;

FIG. 6 is an exemplary graphical user interface providing visualizations of electronic output for instances of a given type of power plant operation as well as selectable choices for a user to electronically select instances and filtering parameters for application to the electronic output;

FIG. 7 is a second exemplary visualization of power plant data analyzed in accordance with the disclosed technology, more particularly illustrating a trend chart of a given parameter associated with multiple instances of a given type of power plant operation;

FIG. 8 is an exemplary graphical user interface element providing selectable choices for a user to electronically select a particular type of power plant operation to analyze in accordance with the disclosed techniques;

FIG. 9 is an exemplary graphical user interface element providing selectable choices for a user to electronically select a particular type of visualization of the disclosed power plant instance analysis;

FIGS. 10-15, respectively, concern an example of the disclosed analysis and display techniques relative to a power plant start operation, where:

FIG. 10 is an exemplary screenshot of a start summary;

FIG. 11 is an exemplary screenshot including selectable graphical user interface features by which a user can select the setup parameters for a start comparison;

FIG. 12 is an exemplary screenshot of a start comparison plotting the total operation time versus initial steam turbine (ST) rotor temperature;

FIG. 13 is an exemplary screenshot of a start dissection for a particular selected instance of a start operation;

FIG. 14 is an exemplary screenshot of a segment comparison comparing the segment durations of a given instance of a start operation to those of other starts; and

FIG. 15 is an exemplary screenshot of the rotor stress profiles experienced during a particular start instance; and

FIG. 16 is a graphical illustration of exemplary key events and segmentation for an instance of an 0-1 start operation within a power plant example.

### DETAILED DESCRIPTION OF THE INVENTION

Reference is now made to particular embodiments of the invention, one or more examples of which are illustrated in the drawings. Each embodiment is presented by way of explanation of aspects of the invention, and should not be taken as a limitation of the invention. For example, features illustrated or described with respect to one embodiment may be used with another embodiment to yield a still further embodiment. It is intended that the present invention include these and other modifications or variations made to the embodiments described herein.

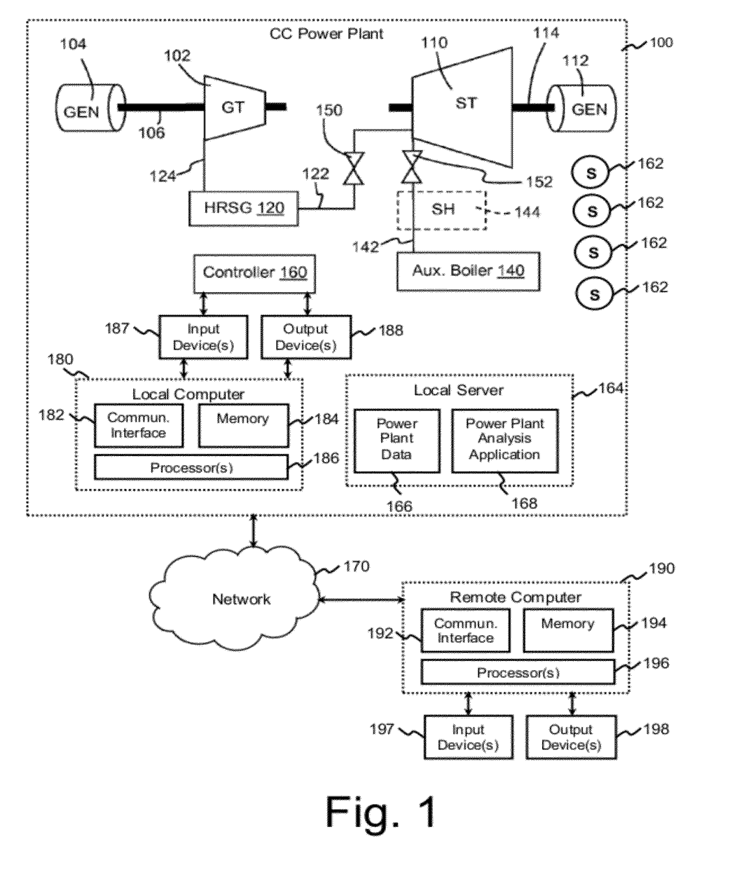

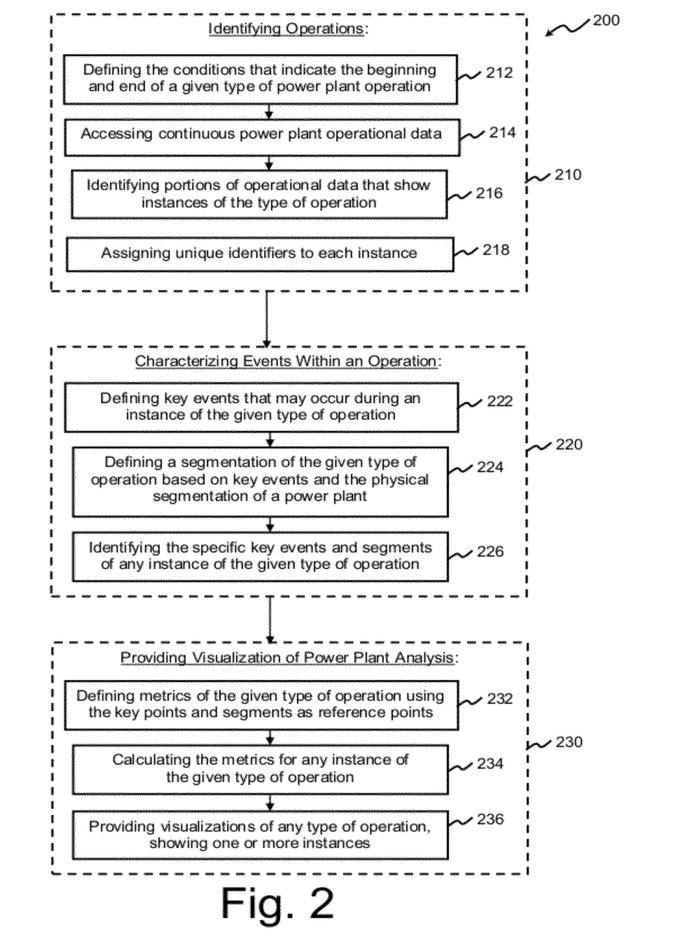

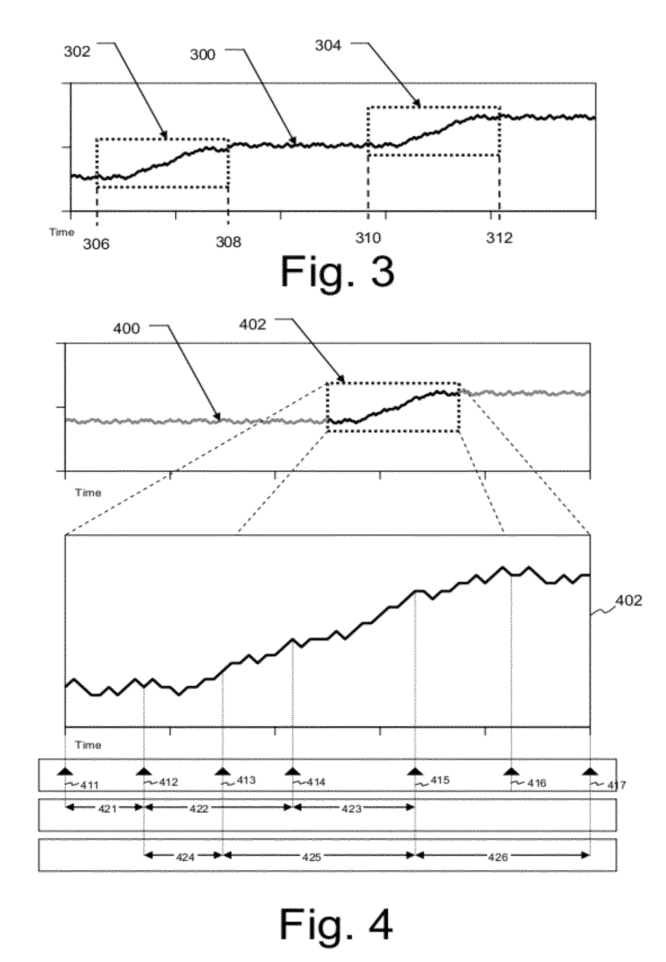

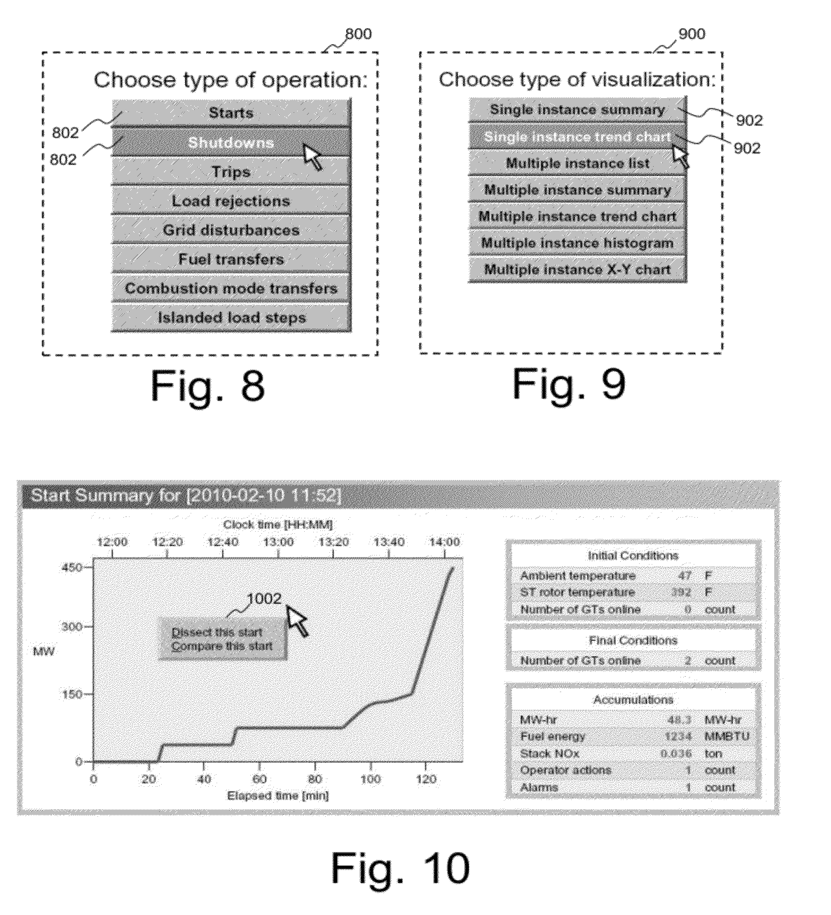

In general, FIGS. 1-16 illustrate various aspects of the presently disclosed systems and methods for implementing automated electronic identification, characterization and visualization of power plant operations. FIG. 1 illustrates various exemplary hardware and software components that may be used in one of the subject systems. FIG. 2 illustrates exemplary steps in a method of implementing exemplary aspects of the disclosed technology. FIGS. 3-9 illustrate general examples of selected characterization and visualization for power plant operations that may be implemented in accordance with various embodiments of the disclosed technology. FIGS. 10-16 illustrate more particular non-limiting examples of selected characterization and visualization for start operations in a power plant environment that may be implemented in accordance with various embodiments of the disclosed technology.

Referring now to FIG. 1, a primary physical component of a system for implementing aspects of the disclosed technology corresponds to a software package including a power plant analysis application 168. The power plant analysis application 168 is a software-based module comprising a set of computer-readable and executable instructions that are stored on a tangible computer-readable medium. In the example of FIG. 1, the power plant analysis application 168 is stored on a local server 164, server 164 being provided locally to one or more power plants, such as combined cycle (CC) power plant 100. Power plant analysis application 168 accesses and analyzes power plant data 166, such as may be received from a controller 160 interfaced with a plurality of sensors 162 that are provided within power plant 100 for tracking and capturing various monitored characteristics of power plant 100. It should be appreciated that although the power plant data 166 and power plant analysis application 168 are depicted in FIG. 1 as being stored at a local server location 164, the memory containing such computer-readable data and instructions may actually be located in a variety of locations local to or remote from a power plant.

Referring still to power plant analysis application 168, the computer-readable information stored within such software module includes various preconfigured definitions defining one or more power plant operations as well as key events and segmentation within such operation(s). For example, the preconfigured or user-customized definitions identify combinations of characteristics within a power plant that signify the beginning and the end of one or more particular types of operations. For example, power plant operations may include but are not limited to starts, shutdowns, trips, load rejections, grid disturbances, fuel transfers, combustion mode transfers, islanded load steps, periods suitable for steady-state performance evaluation, loading, unloading, and transients affecting component life. Different key events and corresponding segmentation of time periods between and among such events may also be defined. Establishing such plurality of preconfigured electronic definitions about power plant operations, key events and segments are variously referred to in FIG. 2 as steps 212, 222 and 224.

The continuous real-time power plant data 166 that is received from the plurality of sensors 162 or other monitoring devices within power plant 100 are then processed relative to the preconfigured definitions mentioned above. For example, selected monitored characteristics of the power plant are accessed (see, e.g., step 214 of FIG. 2) and analyzed to determine when the beginning and the end of a particular operation have occurred. Such determination results in the identification of each instance of a particular type of plant operation (see, e.g., step 216 of FIG. 2). Once such instances are identified, unique identifiers can be assigned to such instances (see, e.g., step 218 of FIG. 2). In some embodiments, the monitored plant characteristic data associated with identified instances can be extracted. In other embodiments, such data associated with identified instances can be indexed by setting indices that bound the data within the continuous data stream according to the beginning and the end of the instances.

By identifying specific instances of given types of plant operations and storing the monitored characteristic data associated with such instances (e.g., the tracked data occurring between the beginning and end times of an identified instance), it is possible to pare down the power plant data 166 from a collective mass of information to specific meaningful portions thereof. The extraction of only meaningful portions of the power plant data helps optimize the amount of information that needs to be stored for potential access in the future, thus minimizing required memory storage capacity and also increasing bandwidth for data access and relay of the power plant data to other local or remote computer-accessible locations. Not only are data transfer rates optimized, but ease of accessibility for power plant data is also improved by assigning unique identifiers for each identified instance of a type of operation. Using the unique identifiers, the subject system can recall data portions associated with only particular types of operations as opposed to all monitored data associated with a power plant time period.

Once instances of one or more particular types of power plant operations are identified within the power plant analysis application, specific items within the data associated with each instance may also be identified. For example, as indicated in step 226 of FIG. 2, specific key events and operational segments associated with a particular type of operation may be identified within the data associated with each instance to also facilitate subsequent analysis of the different instances of one or more power plant operations. Key events are particular data elements identified within the monitored data characteristics associated with an instance of a plant operation. For example, detection of gas turbine (GT) roll-off, detection of a GT flame and detection of a GT generator breaker closing may be key events identified within the monitored characteristics of a CC power plant start operation. Segments generally correspond to predefined portions of a particular power plant operation that are defined relative to selected key events as well as physical segmentation of the different functional components within a power plant (e.g., gas turbines, steam turbines, heat recovery steam generators, superheaters, etc.) For example, a data segment corresponding to the purge and ignition portion within a power plant start operation may correspond to the monitored characteristic data obtained between a first event (namely, the detection of GT roll-off in a given gas turbine) and a second event (namely, the detection of the GT flame for such gas turbine). Additional specific examples of key events and segments within a particular type of power plant operation will be provided throughout the description and will be understood by one of ordinary skill in the art upon review of the present disclosure.

Various pieces of information pertaining to the identified instances, as well as the key events and segments within each instance, may ultimately be provided as electronic output to a user in the form of various data visualizations (e.g., step 236 of FIG. 2). Data visualizations may include one or more of a variety of graphical output formats, including but not limited to summary charts, pie charts, data listings, histograms, trend charts, X-Y plots, box plots, or other graphs, charts, tables or other visually displayed or printed electronic representations of identified and characterized information associated with one or more instances of a power plant operation. In some embodiments, the data visualizations may relay electronically quantified performance aspects for selected identified instances by comparing data parameters associated with identified instances to predefined metrics associated with the given type of operation.

For example, referring still to FIG. 1, a user accessing the subject power plant analysis application 168 from a local computer 180 or a remote computer 190 linked via network 170 may be able to access preconfigured visualizations of various data associated with selected identified instances of a power plant operation. Such visualizations may be displayed or printed, for example, using one or more output devices 188, 198 provided at respective computers 180, 190. Computers 180, 190 may also include input devices (e.g., 187 and 197) to select specific features for viewing, such that customized visualizations based on selectable user configurations are possible as described herein. Input device 187 and output device 188 associated with local computer 180 may also be configured to provide input and output features for the controller 160 or other devices located at the CC power plant 100.

Referring more particularly to FIG. 1, CC power plant 100 may include a variety of particular components, each having certain characteristics that may be monitored using the plurality of sensors 162 or other comparable monitoring equipment suitably provided to track parameters associated with the components of power plant 100. The data from such sensors 162 may then be interfaced to a user through controller 160. The physical components shown and described with reference to FIG. 1 are simplified to provide a descriptive example of the types of power plant components whose characteristics may be monitored to provide power plant data 166. As such, the components of FIG. 1 should in no way be considered a limiting feature of the presently disclosed technology.

In the exemplary embodiment of FIG. 1, power plant 100 includes one or more gas turbine(s) (GT) 102 coupled to a generator 104. A rotating shaft 106 operatively couples gas turbine 102 to generator 104 such that power can be generated from the turning of rotating shaft 106 by gas turbine 102. Power plant 100 also may include a steam turbine (ST) 110 coupled to a generator 112. A rotating shaft 114 operatively couples steam turbine 110 to generator 112 such that power can be generated from the turning of rotating shaft 114 by steam turbine 110. Although shown as separate generators 104, 112, it is possible that both turbines 102, 110 power the same generator.

Referring still to FIG. 1, a heat recovery steam generator (HRSG) 120 may be provided for generating a first steam flow 122 from exhaust 124 from gas turbine 102. That is, exhaust 124 from gas turbine 102 is used to heat water to generate a steam flow 122, which is applied to steam turbine 110. An auxiliary boiler 140 is operatively coupled to steam turbine 110 for producing a second steam flow 142 having characteristics appropriate for starting the steam turbine. Optionally, if necessary, a superheater (SH) 144 may be provided to superheat steam flow 142, e.g., from a saturated steam state created by auxiliary boiler 140. Exemplary power plant 100 of FIG. 1 also includes a first control valve 150 for controlling application of first steam flow 122 to steam turbine 110, and a second control valve 152 for controlling application of second steam flow 142 to the steam turbine.

A controller 160 controls operation of power plant 100 and, in particular, continuously operates the plant in a combined cycle during operation of gas turbine 102 by: starting steam turbine 110 by controlling second control valve 152 to apply second steam flow 142 from auxiliary boiler 140 to the steam turbine, then starting gas turbine 102 and HRSG 120, and then applying first steam flow 122 from HRSG 120 to the steam turbine. Controller 160 may include a computerized control system electrically linked to each component and capable of controlling any mechanisms that control operation of each component, e.g., control valves 150, 152. Sensors 162 or other monitoring equipment may be coupled directly to selected components of power plant 100, or may be interfaced to such components through controller 160 or through other suitable interface mechanisms.

Referring still to FIG. 1, the data obtained from the various sensors 162 in power plant 100 may be provided to a local server 164. For example, the monitored data is represented in FIG. 1 as a database 166 within local server 164 that stores the power plant data. Although illustrated as a single module 166 for storing power plant data, it should be appreciated that multiple databases, servers, or other related computer or data storage devices may be used to store the monitored data from sensors 162. An additional memory module within local server 164 may correspond to the software instructions and definitions provided within power plant analysis application 168. The portions of the raw power plant data that are identified and characterized as corresponding to particular instances of a power plant operation and/or key events and or data segments within such instances may simply be tagged within the power plant data memory module 166 or may be extracted and stored in a different memory location (not shown).

Once the power plant analysis application 168 has automatically identified instances, key events and segments within various types of power plant operations, a user may be able to access and further manipulate such data by accessing features associated with the power plant analysis application 168 via either a local computer 180 or a remote computer 190, both of which may be coupled directly or indirectly via one or more wired or wireless connections to local server 164. Remote computers may be coupled via a network 170, which may correspond to any type of network, including but not limited to a dial-in network, a utility network, public switched telephone network (PSTN), a local area network (LAN), wide area network (WAN), local area network (LAN), wide area network (WAN), metropolitan area network (MAN), personal area network (PAN), virtual private network (VPN), campus area network (CAN), storage area network (SAN), the Internet, intranet or ethernet type networks, combinations of two or more of these types of networks or others, implemented with any variety of network topologies in a combination of one or more wired and/or wireless communication links.

Each computer 180, 190 may respectively include one or more communication interfaces 182, 192, one or more memory modules 184, 194 and one or more processing devices such as a microprocessor or the like 186, 196. Computing/processing device(s) 186, 196 may be adapted to operate as a special-purpose machine by executing the software instructions rendered in a computer-readable form stored in memory/media elements 184, 194. When software is used, any suitable programming, scripting, or other type of language or combinations of languages may be used to implement the teachings contained herein. In other embodiments, the methods disclosed herein may alternatively be implemented by hard-wired logic or other circuitry, including, but not limited to application-specific circuits.

Memory modules contained within local server 164, local computers 180 and/or remote computers 190 may be provided as a single or multiple portions of one or more varieties of computer-readable media, such as but not limited to any combination of volatile memory (e.g., random access memory (RAM, such as DRAM, SRAM, etc.) and nonvolatile memory (e.g., ROM, flash, hard drives, magnetic tapes, CD-ROM, DVD-ROM, etc.) or any other memory devices including diskettes, drives, other magnetic-based storage media, optical storage media, solid state storage media and others. Exemplary input device(s) 187, 197 may include but are not limited to a keyboard, touch-screen monitor, eye tracker, microphone, mouse and the like. Exemplary output device(s) 188, 198 may include but are not limited to monitors, printers or other devices for visually depicting output data created in accordance with the disclosed technology.

Referring now more particularly to FIG. 2, a method of analyzing power plant data in accordance with the disclosed techniques generally includes three different categories of steps which may be performed in the order depicted in FIG. 2 or in other orders. A first category of steps 210 generally corresponds to those pertaining to identifying different types of power plant operations. A second category of steps 220 generally corresponds to characterizing events and segments within an operation. A third category of steps 230 generally corresponds to providing one or more visualizations of power plant analysis, including the identification and characterization implemented in categories 210 and 220.

As part of group 210 concerning identification of power plant operations, a first step 212 involves defining the plant characteristics that indicate the beginning and the end of one or more particular types of power plant operations. Step 214 then involves accessing continuous power plant operational data, such that an identification can occur in step 216 whereby portions of the power plant operational data are identified as instances of the given type(s) of power plant operations. Once such instances are identified in step 216, they can be assigned respective unique identifiers in step 218 such that subsequent data access can determine the different types of power plant operations and other information simply by accessing the identifiers associated with each instance. In some embodiments, the monitored plant characteristic data associated with identified instances can be extracted. In other embodiments, such data associated with identified instances can be indexed by setting indices that bound the data within the continuous data stream according to the beginning and the end of the instances. The unique identifiers associated with identified instances can then be attached to either the extracted portions of data or to the indices that bound the data to facilitate later access to such data. In some embodiments, the unique identifiers associated with particular instances also store information on the date and time of each instance and/or the type of operation.

In the grouping 220, steps 222 and 224 involve establishing electronic definitions for key events and segments, respectively, similar to the step of defining the characteristics associated with the beginning and end of instances established in step 212. A first step 222 involves defining key events that may occur during an instance of a given type of operation. Step 224 involves defining a segmentation of the given type of operation into time-based segments based on selected key events as well as the physical segmentation of a power plant. Finally, step 226 involves identifying the specific key events and segments within any instance of the given type of operation. The data analysis in step 226 involves determining the occurrences and times of the key events and the segments within each instance based on the definitions established by steps 222 and 224. The results of such analysis can then be stored with the extracted operational data or with the indices into the continuous operational data, for each individual instance of an operation.

Once instances, key events and segments are identified, the visualizations and metric calculations provided in steps 230 provide an even further level of analysis and meaningful access to the selectively characterized and identified power plant data portions. For example, some steps concern electronically quantifying performance aspects for selected identified instances of a given power plant operation by comparing various data parameters associated with the identified instances to predefined metrics. More particularly, step 232 involves establishing electronic definitions for metrics of a given type of operation, i.e., performance benchmarks by which the performance within one or more particular instances can be evaluated. The calculation of metrics and actual provision of the quantifiable results can then be provided in step 234 where metrics are calculated for any instance of the given type of operation. Finally, visualizations of any type of operation, including the calculated metrics or selected features of the identified instances, key events and/or segmentation determined in other steps of method 200 may be provided in step 236.

Exemplary aspects of the method steps set forth in FIG. 2 may be more particularly appreciated from the illustrations provided in FIGS. 3-9, respectively. For example, FIG. 3 provides a graphical illustration of instance identification in which continuous plant operational data is analyzed to determine instances of one or more given types of operations, such as referenced in step 216. FIG. 3 plots the continuous operational data 300 for one particular monitored plant characteristic versus time. This continuous data stream 300 is analyzed to determine that a first instance 302 of a particular type of power plant operation occurs where the plotted characteristic 300 increases from a first level to a second level, and a second instance 304 of that same type of operation occurs where the plotted characteristic increases from the second level to a third level. It should be appreciated that FIG. 3 shows the identification of first and second instances relative to only one monitored characteristic within a power plant. This illustration is simplified for ease of description, and the identification of operational instances will more often than not depend on the simultaneous comparison of multiple monitored parameters to the characteristics defining an instance.

As previously described, once the first and second instances 302 and 304 are identified, the portion of the data signal 300 within those instances (i.e., the data within the dashed-line boxes defining instances 302 and 304) may be extracted. Additionally or alternatively, in order to index the data associated with identified instances, time indices corresponding to the identified instances can be saved. For example, time indices corresponding to times 306 and 308 representing the beginning and end of instance 302, and therefore bounding the data contained within first instance 302, may be saved. Similarly, time indices corresponding to times 310 and 312, representing the beginning and end of second instance 304, may also be saved.

Referring now to FIG. 4, once an instance is identified and indexed in accordance with the disclosed technology, additional analysis of an instance can occur by identifying key events and segmentation thereof, such as indicated in step 226 of FIG. 2. For example, assume that instance 402 is identified as a corresponding with a defined type of power plant operation, as determined by comparing the monitored characteristic data 400 with the preconfigured definitions for such a particular type of operation. The data within instance 402 that may be extracted or indexed in accordance with the disclosed technology is shown in magnified view in the lower half of FIG. 4. The plotted data within instance 402 can then be more particularly analyzed to determine that key events have occurred at timing locations 411, 412, 413, 414, 415, 416 and 417, respectively. Based on these key events and other aspects of the preconfigured definitions associated with the particular type of power plant operation identified in FIG. 4, segments 421, 422, 423, 424, 425 and 426 may be defined. For example, segment 421 is defined as the portion of instance 402 occurring between key events 411 and 412. Segment 422 is defined as the portion of instance 402 occurring between key events 412 and 414. Segment 423 is defined as the portion of instance 402 occurring between key events 414 and 415. Segment 424 is defined as the portion of instance 402 occurring between key events 412 and 413. Segment 425 is defined as the portion of instance 402 occurring between key events 413 and 415. Segment 426 is defined as the portion of instance 402 occurring between key events 415 and 417.

Once identification of instances as depicted in FIG. 3 and characterization of key events and segments as depicted in FIG. 4 have occurred for a particular type of power plant operation, a variety of different visualizations for that type of power plant operation can occur. In one example, a visualization corresponds to a summary of individual instances of a type of power plant operation (e.g., power plant starts) including metrics and graphical elements such as a chart of power plant output versus time. In another example, a visualization may include a listing of all or a selected group of instances of a type of operation, including their unique identifiers and selected key characteristics.

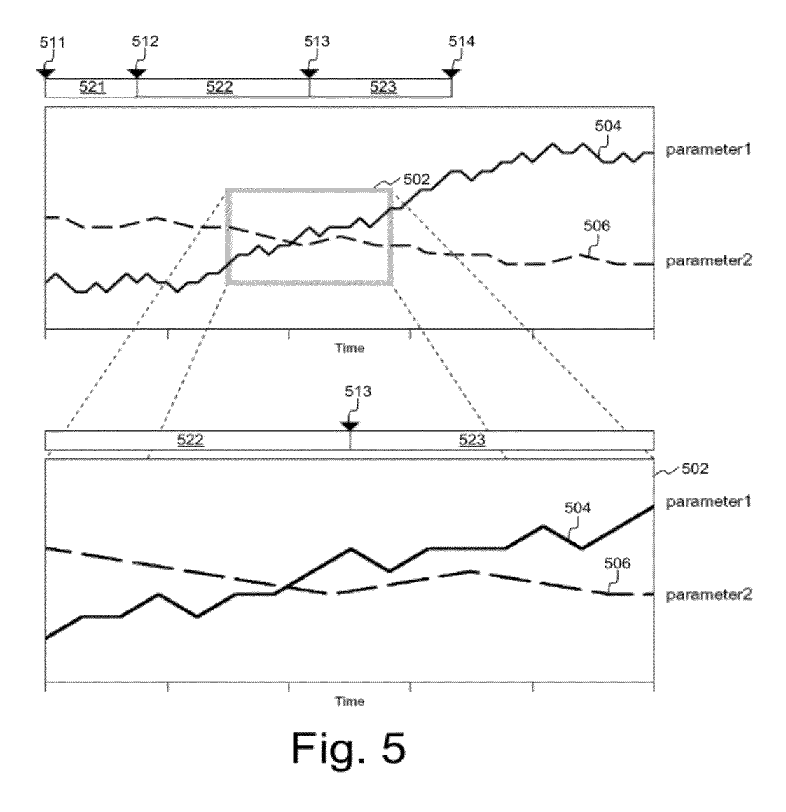

In a still further example, as depicted in FIG. 5, one exemplary visualization corresponds to a trend chart showing data from a particular instance 502 of a type of operation. Such trend charts or others may plot one or more time-dependent data parameters (e.g., parameter1 504 and parameter2 506) of power plant operation on one or more vertical axes, while showing the universal time, local time, or elapsed time relative to any key event in the type of operation plotted along the horizontal axis. Key events within instance 502, namely events 511, 512, 513 and 514, as well as time segments, namely segments 521, 522 and 523, may also be shown within the trend chart visualization. In addition, a magnified “timeline bar” showing the determined events and segments of the instance of the type of operation, such as shown in the lower portion of FIG. 5 may also be illustrated. The timeline bar is maintained in alignment with the horizontal axis even as the range of that axis changes.

Still further examples of visualizations that may be implemented in accordance with the disclosed technology may include one or more of the following data illustration options for displaying selected characteristics of one or more instances of a given type of power plant operation: trend charts, histograms, box plots, pie charts, X-Y plots, or other variable based representations. For example, an exemplary histogram of a single characteristic of a type of operation may provide a count number for occurrences of the characteristic across all or a selected group of instances of a type of power plant operation. An exemplary box plot may show a single characteristic of a given type of power plant operation relative to the characteristics of a selected group of instances of the given type of plant operation. In some exemplary box plots, the units for the given characteristic are plotted along the horizontal axis, a metric box provides a window depicting statistical values for the characteristic defined by a metric, and a bar indicates where the characteristic associated with the particular analyzed instance falls within the metric box. In exemplary pie charts, a single characteristic of a given type of plant operation may be illustrated across a selected group of instances of the given type of plant operation such that the percentage of instances having different values for the given characteristic are represented as different respective pieces of the pie. Exemplary X-Y plots may show respective (X,Y) data points from selected instances of a type of operation, where X and Y are different characteristics (e.g., characteristic1 and characteristic2) of a given type of plant operation. In other visualizations, a combination of selected visualizations described above or others may be provided in a single user output. For example, a summary of all or a selected group of instances of any type of operation may be provided, including counts, statistics and graphical elements like trend charts, pie charts, box plots and histograms.

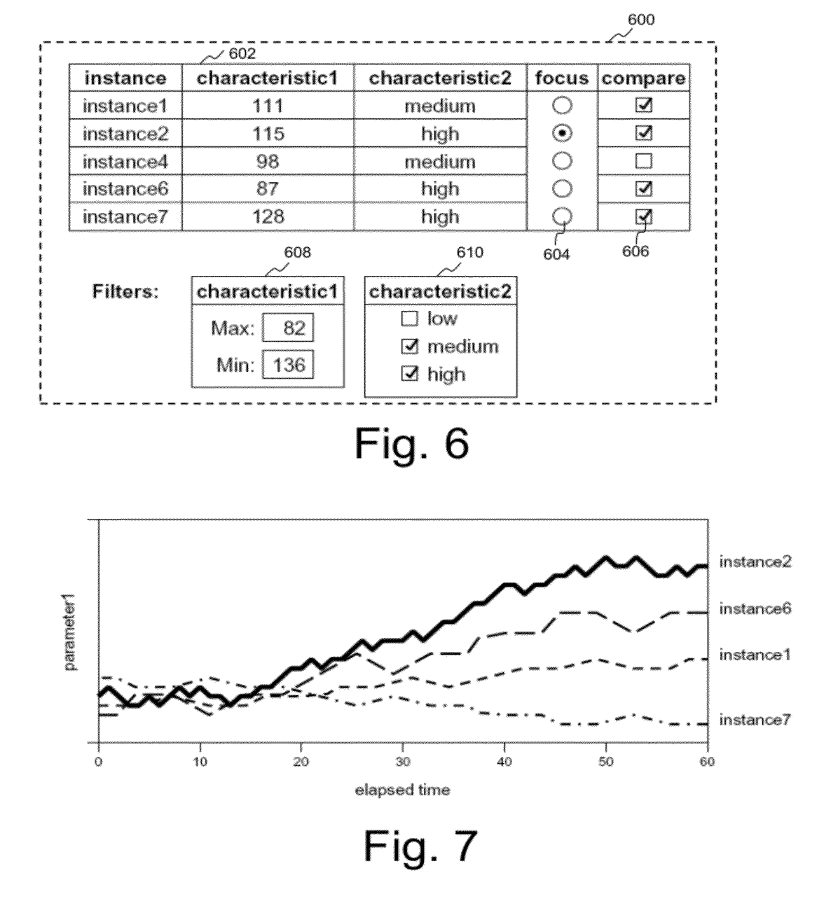

Additional features may be provided in conjunction with one or more of the visualizations described above for filtering, highlighting or otherwise selecting certain customizable features of various power plant visualizations. Referring now to FIG. 6, exemplary graphical user interface 600 may provide a listing or table 602 of different instances, including selected characteristics (e.g., characteristic1 and characteristic2) associated with such instances. Selectable interface features (e.g., selectable buttons 604 and checkable boxes 606) are provided such that a user can select particular instances for a subsequent visualized comparison and/or one or more instances of focus. For example, in FIG. 6, the selectable boxes 606 are provided whereby a user can check to include selected instances within the listing 602 for inclusion in a subsequent visualization corresponding to a trend chart, plot, etc. One or more selectable buttons 604 may also be provided by which a user can choose any one or more instances of a type of operation as the “instance of focus” such that the selected particular instance(s) are highlighted in the different visualizations presented after selection.

As shown in FIG. 6, instance2 is selected as the instance of focus, and instances 1, 2, 6 and 7 are selected for a comparison. Assuming that a user wants to initiate a multiple instance trend chart as the type of visualization, results of the graphical user interface selection elements 604 and 606 as depicted in FIG. 6 could look like the visualization shown in FIG. 7. The trend chart of FIG. 7 illustrates a plurality of instances (i.e., instance1, instance2, instance6 and instance 7) of a given parameter (i.e., parameter1) associated with power plant operation plotted versus elapsed time relative to any selected key event in the type of operation. As also shown in FIG. 7, instance2 is highlighted, or the “instance of focus,” as represented by the thicker bold line plotted in the trend chart.

Referring still to FIG. 6, additional features may be provided whereby a user can also define and apply filters (e.g., filters 608 and 610 to a full set of instances shown in listing 602, based on one or more attributes of the instances (e.g., characteristic1 and characteristic2), and to have only those instances passing through the filters show in the listing 602, a subsequent listing or other visualizations. Some data filters may correspond to established ranges of a power plant characteristic defined between respective minimum and maximum values or defined to include selected types of possible values. For example, as shown in FIG. 6, a user may define filter 608 such that only data for characteristic1 falling within a range of 82 to 136 are displayed and filter 610 such that only data for characteristic2 indicating that the characteristic falls within a medium or high range as opposed to a low range are displayed.

It should be appreciated that the features described above whereby options are included for a user to select different instances, filtering options, highlighting and the like may all be implemented by the computer-readable instructions provided as part of the subject power plant analysis software application 168. For example, a processing device accessing such instructions may be configured such that the processing device generates a graphical user interface for display to a user via one or more output devices. The graphical user interfaces may show such selectable options to a user, and a user may then select such options using an input device associated with the user's computer. One example of a graphical user interface corresponds to interface 600 of FIG. 6. Additional examples of graphical user interface elements are shown in FIGS. 8 and 9

For example, referring now to FIG. 8, one exemplary graphical user interface element 800 may be provided that includes a plurality of different selectable display options 802 corresponding to different types of power plant operations. A user can select one or more of the different selectable display options 802 for which to conduct the subject analysis. Non-limiting examples of the types of power plant operations as shown in FIG. 8 include starts, shutdowns, trips, load rejections, grid disturbances, fuel transfers, combustion mode transfers and islanded load steps.

Referring to FIG. 9, another exemplary graphical user interface element 900 may be provided that includes a plurality of different selectable display options 902 corresponding to different types of visualizations. A user can select one or more of the visualizations, including any of the examples described herein or the non-limiting listing as shown in FIG. 9, including a single instance summary, a single instance trend chart, a multiple instance list, a multiple instance summary, a multiple instance trend chart, a multiple instance histogram and/or a multiple instance X-Y chart.

Having now referred to different general options for implementing the subject technology, a specific example of analysis and visualization is now presented with respect to FIGS. 10-15. To appreciate the potential application of the disclosed technology, consider a hypothetical scenario in which a power plant failed to meet its expected start-up performance criteria. In the example of FIG. 10 showing an exemplary start time of 11:52 am, the power plant failed to meet its 1:50 pm commitment of 450 MW by 15 minutes, costing the plant its start-up costs, lost revenues, and replacement power costs. In order to gain a better understanding of the cause of such exemplary delay, a user may employ the power plant analysis application as described herein to analyze a given type of power plant operation, namely the plant starts.

Referring to FIG. 10, a first option corresponds to providing a user interface including a start summary for the particular start instance identified as beginning on Feb. 10, 2010 at 11:52 am. As shown, the start summary for this instance includes a plot of the overall plant power level in megawatts (MW) plotted versus an elapsed time in minutes (min). Also shown are a data listing of certain key parameters associated with the particular start instance, namely the initial conditions (e.g., ambient temperature, steam turbine (ST) rotor temperature, number of GTs online), and final conditions (e.g., number of GTs online), and accumulations (e.g., MW-hr, fuel energy, stack NOx, operator actions, alarms.) Additional possible data features (not shown) may include the date and time of start, the number of gas turbines online at start, the start temperature class, the start mode, start duration, total Megawatt Hours (MW HR) generated during the start, the initial ST reheat bowl, the temperature for control start, the start termination mode, and/or dates and times from specific key events within the start. From the start summary as shown, a user can take advantage of a user interface feature 1002 whereby the user can select either to dissect a particular instance of a power plant start or compare such start to other start instances.

By toggling the selectable option for “Compare this start,” a user can initiate the display of another graphical user interface corresponding to a setup interface for a start comparison as shown in FIG. 11. A variety of selectable interface elements may be provided in the user interface of FIG. 11 by which a user can select the setup parameters for a start comparison. These selectable interface features within a start setup interface are a particular form of a filter option for the disclosed technology. For example, a user may select comparable starts within an identified data range, starts having an ST rotor temperature within an identified range, one or more different selectable types of starts (e.g., all types, dual GT, lead GT, lag GT, etc.). Additional display features may provide information about the selected start for comparison, the number of starts meeting the selected criteria, and display options defining the type of comparison visualizations desired by the user.

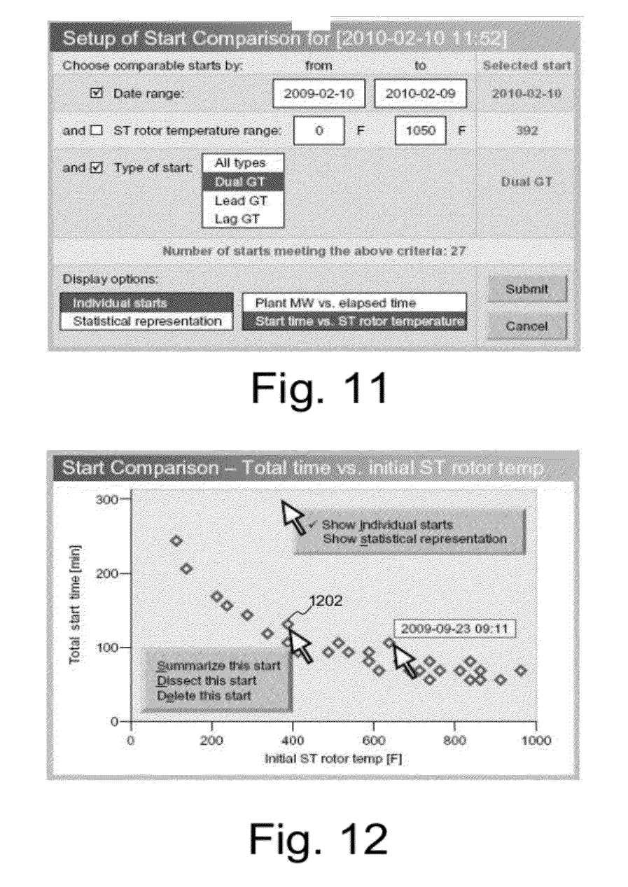

After selecting the features shown in FIG. 11, the system may then generate a new visualization as shown in FIG. 12. FIG. 12 provides an X-Y plot for a plurality of selected start operations, where the X value plotted along the X-axis corresponds to the Initial ST rotor temperature (in degrees F.) and where the Y value plotted along the Y-axis corresponds to the Total start time (in minutes). Each diamond-shaped data point within the plot of FIG. 12 represents a different start, and the data point 1202 represents the particular start of interest. The comparison of the start of interest at point 1202 to the other data points confirms that this start took an additional twenty minutes. At this point, the user can access more detailed information by selecting a user interface element “Dissect this start.”

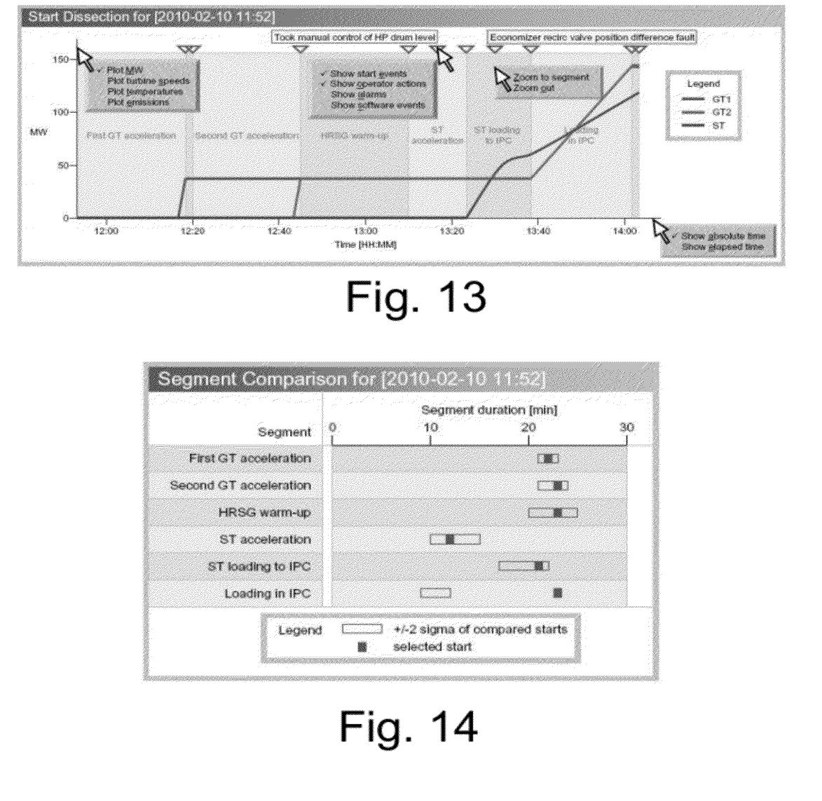

An exemplary start dissection is represented in FIG. 13, and may typically include a time-based plot showing particular key events and segmentation for various turbines (e.g., GT1, GT2 and ST) within a power plant. The particulars of the start dissection show an apparently normal breakdown of the start into segments. It also shows two notable events: (a) a manual intervention by the operators to control HP drum level at about 1:18 pm, and (b) an alarm about the economizer recirculation valve at about 1:27 pm. The intervention of the drum is part of normal procedure, and the alarm was not the cause of the twenty minute delay.

As such, a user may then decide to select additional interface elements within the interface of FIG. 13 to pull up a segment comparison comparing the segment durations of the instance of focus to those of the other selected starts, such as shown in FIG. 14. The segment comparisons shown for different segments of the power plant start in FIG. 14 are in the form of box plots, where the box outlines for each segment show a statistical deviation of +/−2 sigma of the compared starts and the rectangular data points show where the segments for the start of interest fall within the statistical boxes. A comparison of the segment durations for the start of interest to those of other starts revealed that the delay occurred in the Loading in Inlet Pressure Control (IPC) segment of the power plant start operation.

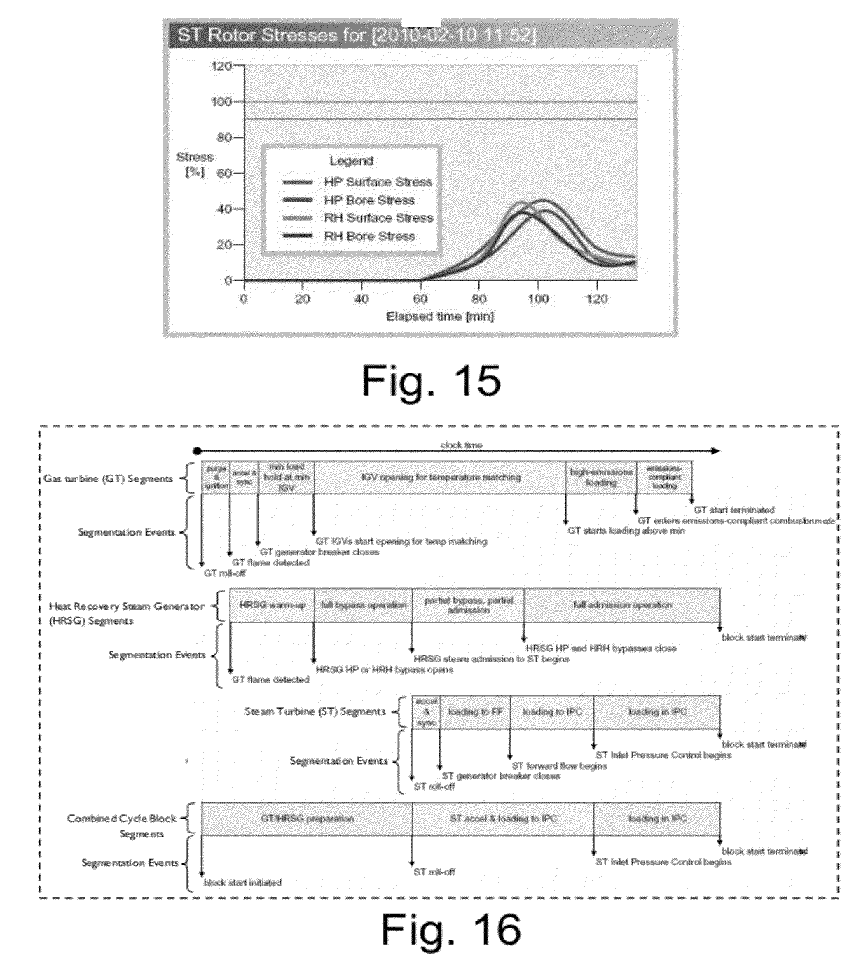

Since ST rotor stresses can be important during a start segment, a user may decide to consider another visualization such as shown in FIG. 15, which is an exemplary screenshot of the rotor stress profiles experienced during the Inlet Pressure Control (IPC) loading segment illustrated in FIG. 14. Such rotor stress profiles reveal that the peaks were well below the target 90% stress levels, perhaps due to an operator's conservatism in elevating GT exhaust temperature. Once determining the cause of the start delay, the user may then provide information for coaching operators and updating operating procedures to prevent a recurrence. As such, use of the disclosed analysis and visualization features can ultimately improve the performance of a power plant by identifying issues and training operators to deal with them in a suitable fashion.

While FIGS. 10-15 provide a helpful specific example of the different types of visualizations that may be available to a user of the subject power plant analysis technology during a start operation, FIG. 16 provides a specific example of how key event identification and segmentation may be defined and implemented for a start operation in accordance with the disclosed techniques. For example, consider that instances of a power plant start are defined relative to key events within various physical components of a power plant, particularly relative to the physical segmentation of the following components: a gas turbine (GT), a heat recovery steam generator (HRSG), a steam turbine (ST) and a combined cycle block. Various logic (i.e., electronic definitions) that defines when an “0-1 start” within such a power plant begins and ends, as well as the key events and further breakdown of the start into segments are stored in memory. For example, a start may be defined as beginning when the monitored gas turbine speed crosses over a predetermined threshold level. Similarly, a start may defined as ending or terminating when all GTs in a power plant have entered an emission-compliant combustion mode, all HSRGs are in full admission operation and steam turbines are loading in the IPC and have a power level exceeding a predetermined MW level for a threshold amount of time. Within the beginning and end of such identified start, additional detection of key events and segmentation can be determined, such as represented by the exemplary segmentation in FIG. 16.

The identification of the given start operation may be implemented by monitoring a plurality of power plant parameters. The output data associated with such monitored parameters are further analyzed to detect key events and to break down the monitored data into segments thereof based on such key events and other related information. For example, key events detected within the gas turbine (GT) may correspond to the exemplary events indicated at each downward arrow associated with the first row of events in FIG. 16. Such events may include GT roll-off, GT flame detection, GT generator breaker closing, GT IGVs start opening for temperature matching, GT starts loading above a minimum threshold level, GT enters emissions-compliant combustion mode and GT start terminated. The coordination between such key events and the segmentation thereof can also be defined within the subject application instructions. For example, the time period (and associated data) from the beginning of the start after GT roll-off has occurred (defined, e.g., as the GT speed exceeding some predetermined level) can be defined as a “purge and ignition” segment. Once in the “purge and ignition” segment, parameters such as the GT gas fuel mass flow and GT exhaust temperature are monitored so that the GT flame can be detected. Once the GT flame is detected, such key event can signal the end of the “purge and ignition” segment within the GT. Similarly, additional characteristics of the GT are monitored (e.g., GT speed and GT power) to determine the next key event, namely the GT generator breaker closing. The occurrence of this key event may then signal the end of a next segment within the GT, namely the “accel and sync” segment. Additional segmentation of data relative to the gas turbine may be defined relative to other key events to include the following exemplary segments: a “min load hold at min IGV” segment, an “IGV opening for temperature matching” segment, a “high-emissions loading” segment, and an “emissions-compliant loading” segment.

Referring still to FIG. 16, additional key events within an 0-1 start operation may be determined relative to monitored parameters within the heat recovery steam generator (HSRG), the Steam Turbine (ST) and the Combined Cycle Block (CCB). As shown in the second row of key events and segmentation, key events for the HSRG may include but are not limited to the GT flame detection, HSRG high pressure (HP) or hot reheat (HRH) bypass opening, HSRG steam admission to the ST beginning, HSRG HP or HRH bypasses closing, and the block start being terminated. Segmentation relative to the key events within the HSRG may result in the following exemplary segments as shown in FIG. 16: an “HSRG warm-up” segment, a “full bypass operation” segment, a “partial bypass, partial admission” segment, and a “full admission operation” segment. As shown in the third row of key events and segmentation, key events for the ST may include ST roll-off, ST generator breaker closing, ST forward flow beginning, ST Inlet Pressure Control (IPC) beginning and the block start being terminated. Segmentation relative to the key events within the ST may result in the following exemplary segments as shown in FIG. 16: an “accel and sync” segment, a “loading to forward flow (FF)” segment, a “loading to IPC” segment, a “loading in IPC” segment. As shown in the fourth row of key events and segmentation, key events for the CCB may include the block start being initiated, the ST roll-off occurring, the ST IPC beginning, and the block start being terminated. Segmentation relative to the key events within the CCB may result in the following exemplary segments: a “GT/HSRG preparation” segment, an “ST acceleration and loading” segment and a “loading in IPC” segment. Although the above key events and segments help provide understanding for how to implement aspects of the disclosed technology within a power plant start operation, it should be appreciated that the same principles can be applied to different types of power plant operations.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A method of electronically analyzing power plant data, comprising:
establishing a plurality of electronic definitions about a power plant, said plurality of electronic definitions comprising: (a) power plant conditions that indicate the beginning and end of at least one given type of power plant operation, (b) key events that may occur during an instance of the at least one given type of power plant operation, and (c) a segmentation of the at least one given type of power plant operation into one or more time-based segments based on the key events and physical segmentation features of the power plant;
electronically accessing continuous power plant operational data;
electronically identifying portions of the power plant operational data that show instances of the at least one given type of power plant operation;
electronically identifying the key events and segments within each instance of the at least one given type of power plant operation; and,
providing the identified instances along with the key events and segments identified within each instance as electronic output.

2. The method of claim 1, wherein said at least one given type of power plant operation comprises one or more of starts, shutdowns, trips, load rejections, grid disturbances, fuel transfers, combustion mode transfers, islanded load steps, periods suitable for steady-state performance evaluation, loading, unloading, and transients affecting component life.

3. The method of claim 1, further comprising assigning unique identifiers to one or more of the identified instances of the at least one given type of power plant operation.

4. The method of claim 1, wherein said continuous power plant operational data comprises live data.

5. The method of claim 1, wherein said continuous power plant operational data comprises historical data.

6. The method of claim 1, further comprising: electronically defining one or more metrics of the at least one given type of power plant operation using the key events and segments as reference points; and, electronically calculating the metrics for selected identified instances of the at least one given type of power plant operation and providing those metrics as electronic output.

7. The method of claim 1, further comprising providing a graphical visualization of selected aspects of the at least one given type of power plant operation and selected identified instances thereof as electronic output to a user.

8. The method of claim 7, wherein the type of graphical visualization provided as electronic output to a user may be selectable from a plurality of electronically presented options to a user, said type of graphical visualization comprising one or more of a summary chart, pie chart, data listing, histogram, trend chart, X-Y plot and box plot relating selected characteristics, events and/or segments of selected instances of the at least one given type of power plant operation.

9. The method of claim 7, further comprising electronically defining and applying data filters to the full set of electronically identified instances of the at least one given type of power plant operation, and providing data associated with only the instances that pass through the applied data filters as electronic output to a user.

10. The method of claim 7, further comprising electronically providing a selectable graphical interface element to a user for receiving user selection of one or more particular instances from the full set of electronically identified instances of the at least one given type of power plant operation to be included in an electronic visualization of multiple instances provided as electronic output to a user.

11. The method of claim 7, further comprising a step of highlighting one or more particular instances of focus in all visualizations involving multiple instances of the at least one given type of power plant operation.

12. The method of claim 7, further comprising a step of electronically providing a selectable graphical interface element to a user by which a user can select to dissect a particular instance of the at least one given type of power plant operation or to compare a particular instance of the at least one given type of power plant operations to other instances of the at least one given type of power plant operation.

13. A power plant analysis and display system, comprising:
at least one processing device;
at least one memory comprising computer-readable instructions for execution by said at least one processing device, wherein said at least one processing device is configured to electronically access continuous power plant operational data, electronically identify portions of the power plant operational data that show instances of at least one given type of power plant operation, as well as predefined key events and segments within each instance of the at least one given type of power plant operation; and,
at least one output device for displaying data associated with selected identified instances and characteristics, key events or segments thereof.

14. The system of claim 13, wherein said computer-readable instructions further configure said at least one processing device to assign unique identifiers to the identified instances of the at least one given type of power plant operation.

15. The system of claim 13, wherein the continuous power plant operational data accessed by said at least one processing device comprises one of live data or historical data.

16. The system of claim 13, wherein said computer-readable instructions further configure said at least one processing device to electronically quantify performance aspects for selected identified instances of the at least one given type of power plant operation by comparing various data parameters associated with the identified instances to predefined metrics.

17. The system of claim 13, further comprising an electronic input device, and wherein said computer-readable instructions further configure said at least one processing device to generate a graphical user interface for display to a user such that a user can select via said electronic input device from a plurality of different power plant operations for analysis by said system.

18. The system of claim 17, wherein the at least one given type of power plant operation comprises one or more of starts, shutdowns, trips, load rejections, grid disturbances, fuel transfers, combustion mode transfers, islanded load steps, periods suitable for steady-state performance evaluation, loading, unloading, and transients affecting component life.

19. The system of claim 17, wherein said computer-readable instructions further configure said at least one processing device to generate a graphical user interface for display to a user such that a user can select via said electronic input device from a plurality of different visualizations for displaying selected data associated with one or more instances of the at least one given type of power plant operation, said selectable visualization options comprising one or more of a summary chart, pie chart, data listing, histogram, trend chart, X-Y plot and box plot relating selected characteristics, events and/or segments of selected instances of the at least one given type of power plant operation.

20. The system of claim 17, wherein said computer-readable instructions further configure said at least one processing device to apply data filters to the full set of electronically identified instances of the at least one given type of power plant operation, and providing data associated with only the instances that pass through the applied data filters as electronic output to a user.
